(19) United States
(12) Patent Application Publication
(10) Pub. No.: US 2003/0215314 A1
(43) Pub. Date: Nov. 20, 2003

(54) Gondola moving device

(76) Inventor: Karl C. Klokke, Boise, ID (US)

Correspondence Address: DYKAS, SHAVER & NIPPER, LLP, P O BOX 877, BOISE, ID, 83701-0877, US

(21) Appl. No.: 10/146,993

(22) Filed: May 15, 2002

(51) Int. Cl. B60P 3/00

(52) U.S. Cl. 414/495

(57) ABSTRACT

A merchandise gondola mover having a pair of jack assemblies and a pair of support connections. The mover's support connections lock onto each side of each of the gondola's horizontal base supports, and are provided with flanges for contacting the bottom surface of the gondola's horizontal base support. Additional flanges are provided for contacting and lifting the bottom surface of the gondola's center post.

### BACKGROUND OF THE INVENTION

1. Field of the Invention

The present invention generally relates to merchandise display gondolas, and more particularly relates to devices utilized to lift, move and set down loaded merchandise gondolas in a second location.

2. Background Information

Gondola-type shelving is commonly used in many stores to display merchandise. The gondola typically has a plurality of upright posts to which horizontal shelves are attached for displaying merchandise. Such a gondola will have a horizontal base support which connects with a floor surface through a number of feet. Such horizontal base supports stabilize the post.

It is frequently necessary, or desirable, for a store to move the gondolas, for example when remodeling or rearranging the store. Gondola movers have been known for many years, and normally include arms having fingers which extend through the apertures in the upright posts, and a jack similar to raising the arms thereby lifting the gondola. Cross braces extend between the adjacent lift arms to stabilize the gondola mover. In the past, all products and merchandise had to be moved from at least the lower gondola shelves before the gondola could be moved. Such unstocking of the shelves is time consuming, and such time doubles when the shelves are restocked after the gondola has been moved. Also, assembly and installation in prior art gondola movers was time consuming because the components of the mover required many bolts to assemble and connect the lift arms to the gondola posts. Of course, all of the timely steps required to assemble and install the gondola mover had to be repeated after the gondola was moved and it was desired to disassemble the gondola mover.

Examples of such gondola movers and improvements upon such gondola movers are shown in U.S. Pat. Nos. 5,716,186 and 4,275,982.

A primary objective of the present invention is the provision of an improved gondola mover.

Another objective of the present invention is the provision of a gondola mover which can be quickly and easily assembled and disassembled.

Another objective of the present invention is a gondola mover which can be utilized while the gondola is still loaded with merchandise.

### SUMMARY OF THE INVENTION

The present invention is an apparatus for moving a merchandise gondola. Such a gondola will have at least one horizontal base support for contacting a floor surface and a number of shelves supported there above. The invention has a first elevation means, a second elevation means and a pair of base support connections for cradling and lifting the horizontal base support and center post of the gondola. The elevation means each have at least one jack assembly mounted on at least one wheel. The elongated base support connections are able to releasably connect between the elevation means with one base support connection on each side (left and right) of the horizontal base support. A number of flanges extend from the bottom of the base support connections for support of the base support during lifting. Thus, when installed on a base support, the jack assemblies are able to raise the attached first and second elongated base support connections thereby lifting the cradled horizontal base support and thereby lifting the gondola.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 is a side view of a first embodiment of the present invention shown installed on and lifting a merchandise gondola.

FIG. 2 shows a partial side view of one embodiment of a jack assembly utilized with the present invention.

FIG. 3A shows a first end view of one embodiment of a jack assembly utilized with the present invention.

FIG. 3B is a second end view of the embodiment shown in FIG. 3A

FIG. 3C is another view of the jack assembly of FIGS. 3A and 3B showing the installation of the elongated base support connections.

FIG. 4 shows a top view of the preferred embodiment of the present invention.

FIG. 5 shows an inside view of one embodiment of an elongated base support connection utilized with the present invention.

FIG. 6 shows an outside view of a second embodiment of an elongated base support connection utilized with the present invention.

FIG. 7 is a side view of the preferred embodiment of the present invention.

FIG. 8 is an exploded view of one embodiment of a jack assembly utilized with the present invention.

FIG. 9 is a top view of one embodiment of an alignment channel utilized with the present invention.

FIG. 10 is a partial top view of how the present invention picks up a gondola center post.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

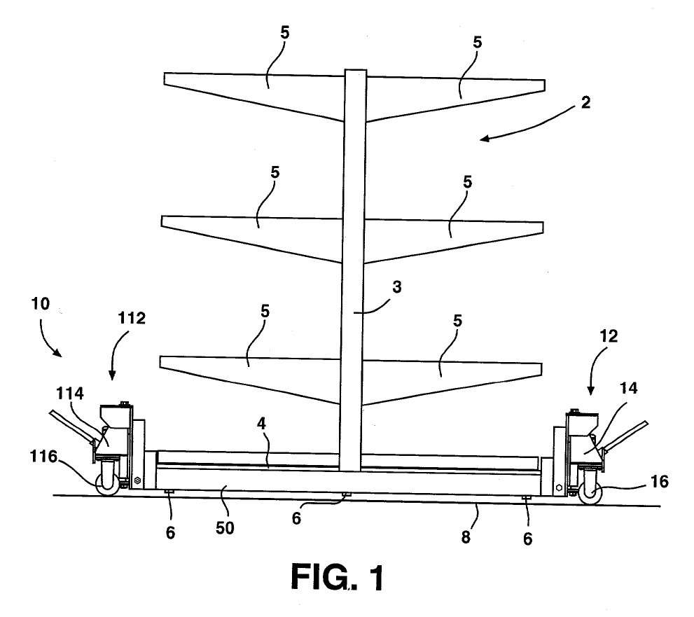

Referring initially to FIG. 1, shown is one embodiment of the merchandise gondola moving device 10, which is the subject of the present invention. The device or apparatus 10 is utilized to lift a merchandise gondola 2, as shown, so that the gondola 2 can be moved. The present invention can be utilized without needing to unload the gondola, a feature that greatly reduces the time required to move the gondola. Such a merchandise gondola 2 has at least one generally vertical post 3 which supports a number of shelves 5. The post 3 typically attaches to a horizontal base support 4 which typically includes a number of feet 6 for contacting the ground surface 8. Alternatively, a gondola could comprise two opposing horizontal base supports which join at the post, but such disclosure is intended to include such an embodiment, and others, as well. Such a description of a merchandise gondola is done generally for illustrative purposes. The present invention is envisioned to work with any configuration of a merchandise gondola, regardless of whether it is described by this specific gondola description.

The embodiment shown in FIG. 1 shows the merchandise gondola 2 being lifted above the ground surface so that the feet 6 are no longer touching the floor 8. The apparatus 10 utilizes a pair of elevation means 12, 112, which are utilized to raise the opposing ends of the horizontal base support 4 thereby lifting the merchandise gondola off the floor. The apparatus 10 further comprises a pair of jack assembles 14, 114 each having at least one wheel 16, 116. It is preferred that the jack assemblies each have a pair of wheels. Operation of these jack assembles serves to lift connected elongated base support connections 50 (50′, not shown), which connect with the horizontal base support 4 to lift the merchandise gondola 2, preferably at least partially via the center post 3.

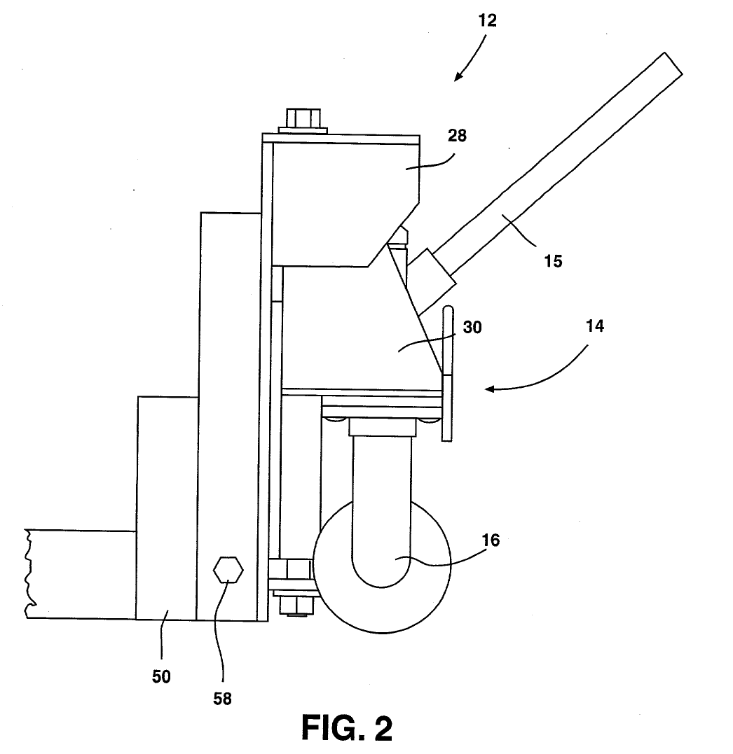

Referring now to FIG. 2, a close-up side view of one embodiment of an elevational means 12 utilized with the present invention is shown. This embodiment of elevation means 12 comprises a jack assembly 14 with a handle 15 able to be articulated by a user thereby resulting in the lifting of the attached connected elongated base support connection 50. This base support connection 50 is able to lift the horizontal base support of the gondola (not shown in this Figure). It is preferred that the elevation means 12 can be maneuvered from one location to the next through the use of the wheel 16 or wheels.

The elongated base support connection 50 is able to releasably, yet fixedly, connect with the elevation means 12 through use of a bolt 58 (or other connection means, i.e., pin) extending through a hole within the elevation means 12 and through an aligned hole within the elongated base support connection 50. Such an aligned hole can also be threaded, or a nut, or other attachment means can be utilized to connect with the connection means thereby fixing the connection 50 in relation to the elevation means 12.

Thus, installation of the base support connection 50 to the elevation means 12 is done through aligning the hole within the elongated base support connection 50 with the hole in the elevation means 12 and inserting the attachment means 58 there-through and securing the attachment means thereon. While not shown in this Fig., the opposing elongated base support connection 50′ connects to the elevation means 12, and the other ends of the elongated base support connections 50/50′ connect to the second elevation means 112 in a similar fashion.

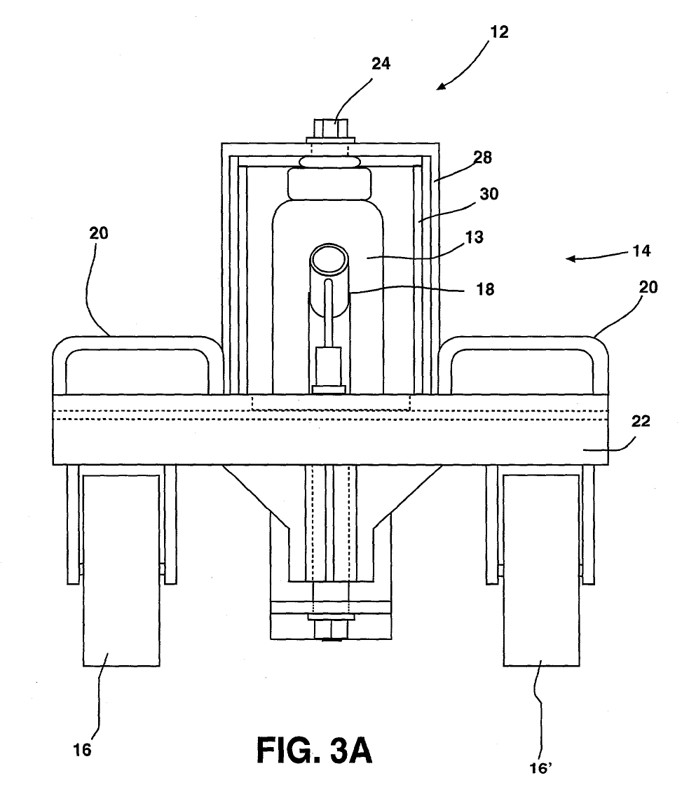

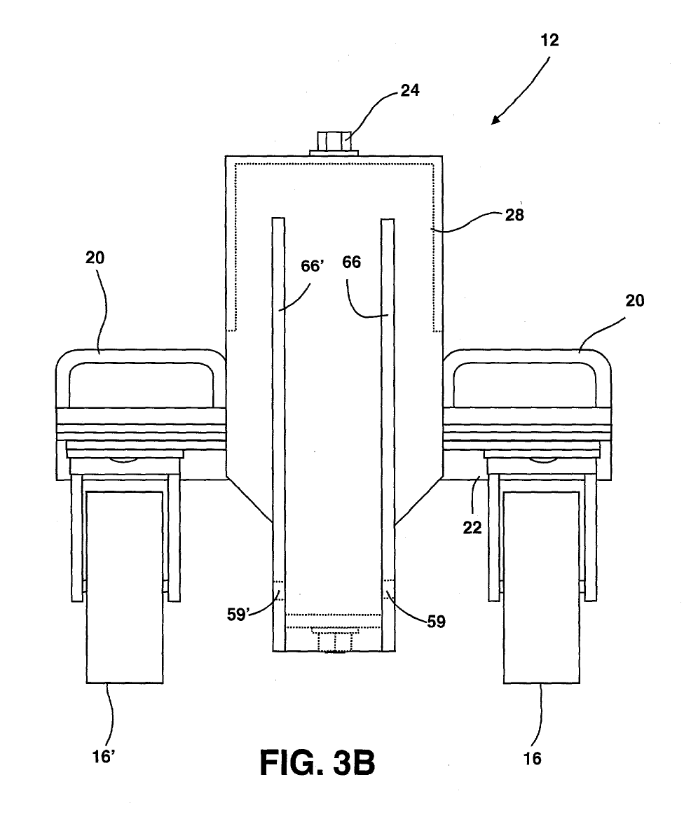

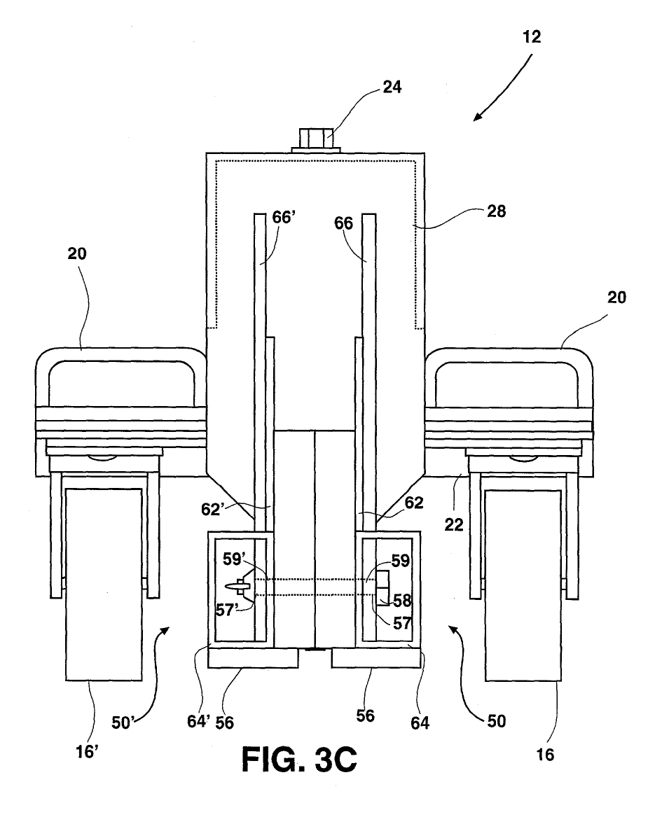

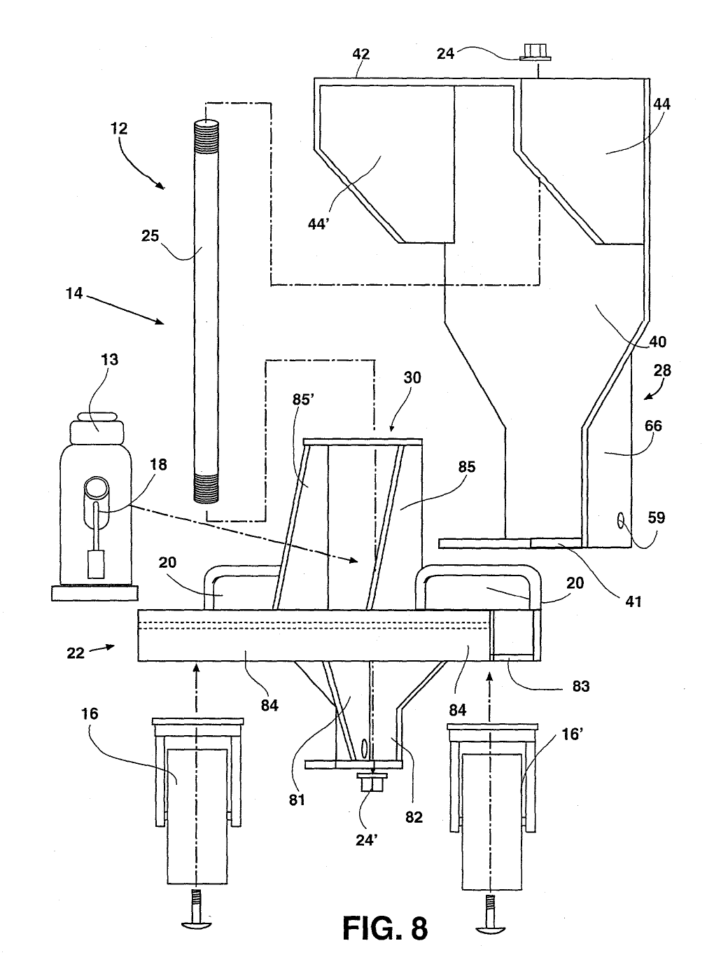

Referring now to FIG. 3A, shown is a first end view of one embodiment of an elevation means 12 utilized with the present invention. The elevation means 12 comprises a jack 13 mounted upon a frame 22. This frame being divided into a first portion 28 and a second portion 30. The jack 13 is interposed between the first portion 28 and the second portion 30. The wheels 16, 16′ connect to the second portion 30. In this embodiment, the wheels 16, 16′ are part of caster assemblies which are bolted to the base plate 83 (see FIG. 8) of the elevation means 12. Other wheel assemblies, including using wheels with axles, are also possible.

It is preferred that the frame 22 further comprise at least one hand hold 20 defined therein thereby allowing a person to more easily lift and carry the present invention to the job site. Optionally, a pull unit with a hook assembly can be provided for allowing a user to pull the present invention after it is installed on a gondola.

Referring now to FIG. 3B, shown is the opposite or second end view of the embodiment of FIG. 3A. This view shows the first portion 28 further comprising a pair of vertical tangs 66, 66′ which serve to connect with the base support connections. This connection is preferably accomplished through use of a pair of frame holes 59, 59′ defined within the tangs 66, 66′. These frame holes 59, 59′ are unthreaded, but could be threaded for receiving a threaded attachment means.

Referring now to FIG. 3C, shown is the view of FIG. 3B as it would appear with the attachment of the elongated base support connections 50, 50′. As can be seen in this embodiment, a support connection 50 (50′) comprises at least one generally horizontal flange 56, at least one stiffener tube 64 (64′) and at least one attachment upright 62 (62′). The flange 56 attaches to the bottom surface of the stiffener tube 64 (64′). The stiffener tube 64 (64′) attaches at each of its ends to one of the uprights 62 (62′). A base support hole 57 (57′) is defined within the upright 62 (62′). This base support hole is able to be aligned with the frame hole 59 (59′) of the tang 66 (66′) so that a bolt 58 (58′), pin or other attachment means can be inserted through the two holes and affixed using a nut 158 (158′), as shown, or other means, thereby releasably attaching the support connection 50 (50′) to the elevation means 12 (12′).

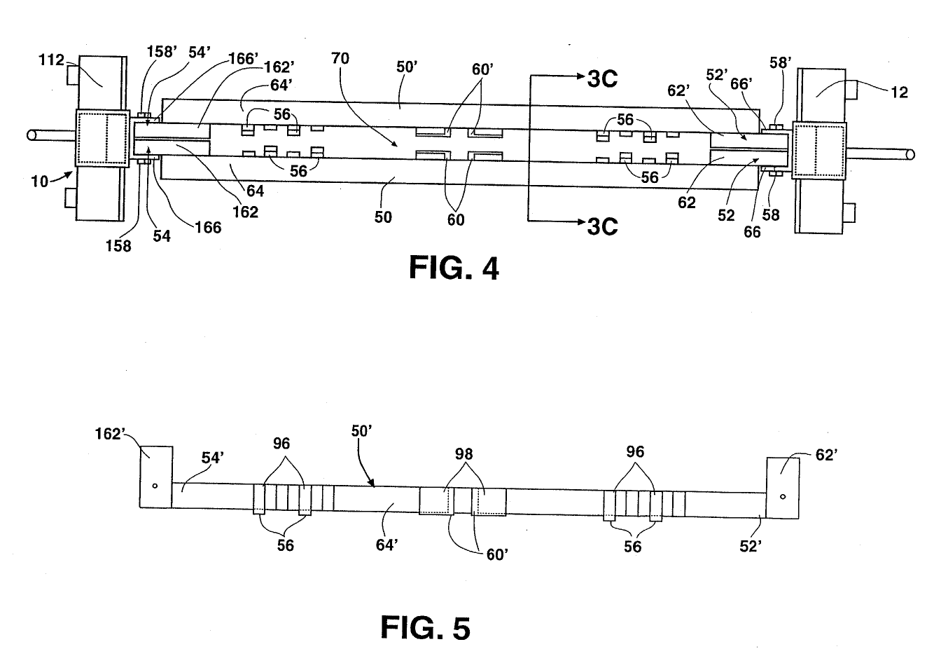

Referring now to FIG. 4, shown is the embodiment of FIGS. 3A-3C. This Figure shows how the present invention attaches together, but does not show the device 10 cradling a merchandise gondola. The apparatus 10, as shown, defines a channel 70 into which the horizontal base support of the gondola will rest. The apparatus 10 has a first elevation means 12 opposite a second elevation means 112. Attaching between these elevation means is a first elongated base support connection 50 and a second elongated base support connection 50′.

These elongated base support connections 50, 50′ being generally “L” shaped in nature (as shown in FIG. 3C), as having a number of flanges 56, which operate to serve as contact points for contacting the horizontal base support (not shown). These flanges 56 preferably configured as shown so that opposing base support connections 50, 50′ have mating flanges 56. Additionally, a number of center flanges 60, 60′ are provided for supporting the four corners of the center post of the merchandise gondola (not shown).

The elongated base support connections 50, 50′ further have first ends 52, 52′ and second ends 54, 54′. The first support connection 50 comprises a pair of uprights 62, 162 which attach at the first and second ends 52, 54 of the support connection 50 to the stiffener tube 64. The second support connection 50′ comprises a pair of uprights 62′, 162′ which attach at the first and second ends 52′, 54′ of the support connection 50′ to the stiffener tube 64′.

The preferred support connections are 65″ long, having a 46″ center section and 9½″ end sections. Note: any measurements listed within this disclosure are intended for reference to the particular embodiment being discussed and are not intended to serve as limitations to other embodiments. The preferred uprights are cut from 4″×8″×¼″ plate having a 9/16″ hole defined therein for receiving the attachment means (bolt) used to fasten to support connections onto the elevation means. This 9/16″ hole being centered 1″ in and 3″ from the bottom of the upright.

The preferred flanges 56 comprise 2¾″×3½″×¼″ plates. These flanges are preferably attached at a ninety degree angle to mounting plates 96 provided on the stiffener tubes, these mounting plates comprising ½″×1½″×3″ plates. It is preferred that two to four mounting plates 96 be located on each end of the stiffener tube, spaced 1½″ inches apart, starting 10½″ from the centerline. In the preferred embodiment, the flanges 56 are preferably configured as shown so that opposing base support connections 50, 50′ have mating flanges 56.

Referring also to FIG. 5, also provided are the center flanges 60, 60′. The preferred center flanges comprise 2½×3½″×¼″ plates. These center flanges 60, 60′ attaching to their own mounting plates 98 comprising ½″×3″×3″ plates, as shown. These center flanges 60, 60′ mounted on the mounting plates 98 so as to have an 1/2 overhang towards the centerline, said center flanges mounted 7/8″ from the center line.

In this embodiment, the elevation means 12, 112 have extending therefrom a pair of tangs 66, 66′ (166, 166′) configured for attachment to the support connections 50, 50′, as shown. Bolts 58, 58′ and wing-nuts 158, 158′ (or other attachment means) can be utilized to attach the support connections 50, 50′ to the uprights 62, 62′, 162, 162′ of the elevation means 12, 112 via the tangs 66, 66′, 166, 166′, as shown. FIG. 7 shows a side view of the embodiment shown in FIG. 4.

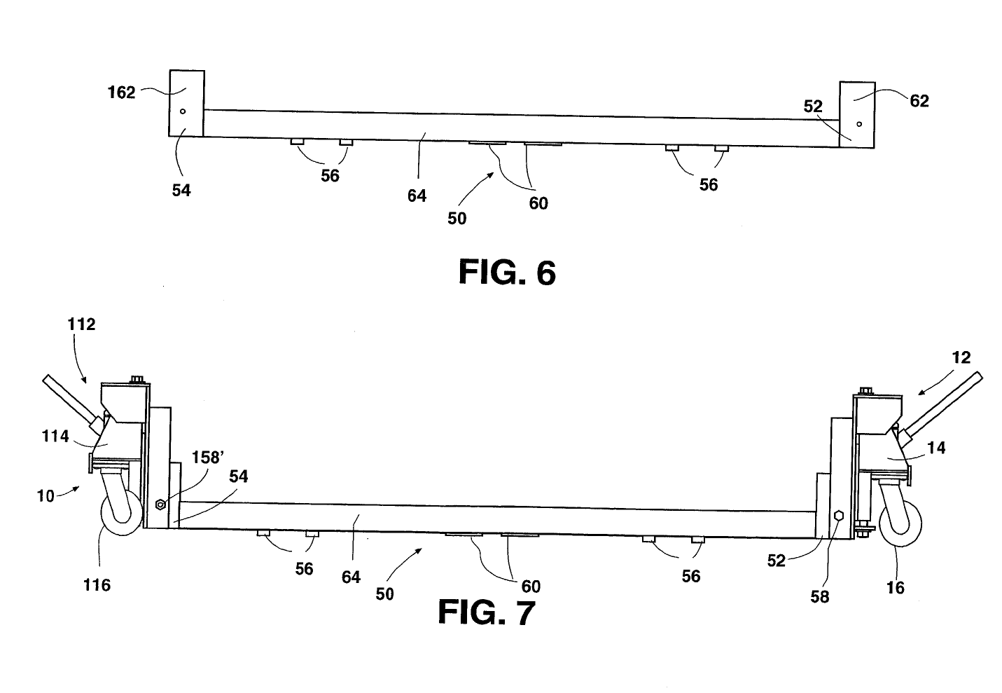

Referring now to FIG. 5, shown is a side view of the inside of one embodiment of a second elongated base support connection 50′. Preferably, the inside of the first elongated base support (the outside of which is shown in FIG. 6) would resemble a mirror image of this figure. The support connection 50′ comprises a pair of uprights 62′, 162′ which attach to the ends (52′, 54′) of the stiffener tube 64′. A number of flanges 56 extend from the base of the elongated base support connection 50′ for contacting the underside of the horizontal base support. These flanges mounting to mounting plates 96. A pair of center flanges 60′ extend from the elongated base support connection 50′ as well for contacting the under side of the center post when the apparatus 10 is utilized with the gondola. These center flanges mounting to mounting plates 98.

Referring now to FIG. 6, shown is a side view of the outside of one embodiment of an first elongated base support connection 50. Preferably, the outside of the second elongated base support (the inside of which is shown in FIG. 5) would resemble a mirror image of this Figure. The support connection 50 comprises a pair of uprights 62, 162 which attach to the ends (52, 54) of the stiffener tube 64. A number of flanges 56 extend from the base of the elongated base support connection 50 for contacting the underside of the horizontal base support. A pair of center flanges 60 extend from the elongated base support connection 50 as well for contacting the under side of the center post when the apparatus 10 is utilized with the gondola. FIG. 7 shows a side view of the embodiment shown in FIG. 4.

Referring now to FIG. 8, shown is an exploded view of one embodiment of a jack assembly utilized with the present invention. This jack assembly 14 utilizes an elevation means 12, and a jack 13, such as the hydraulic jack shown. A handle connection 18 is preferably provided for actuation of the jack 13 through use of a handle, as shown in the embodiment of FIG. 2. The elevation means 12 is provided with a frame 22, preferably having at least one hand hold 20 for allowing a user to more easily move the assembly around. The elevation means 12 has a first potion 28 and a second portion 30.

The first portion 28 comprising the tang 66 utilized to connect with the elongated base support connection via a bolt fastened through the frame hole 59 provided. Through its attachment through use of the spindle 25 and nuts 24, 24′, the first portion 28 is able to be lifted in relation to the second portion 30 via the jack 13. A pair of wheels 16, 16′, mounted on casters are also preferably provided.

In the preferred embodiment, the first portion 28 comprises a main plate 40, a bolt guide 41, a top plate 42, a pair of side plates 44, 44′ and a pair of tangs 66 (66′ not shown). The preferred main plate is cut from plate 5⅛″×16½″×¼″ plate. The preferred tangs (wing plates) are cut from 2″×14½″×¼″ plate, having a 9/16″ hole therethrough 1 1/16″ from main plate and 3″ from the bottom edge. The tangs are preferably spaced 2 5/16″ apart. The preferred top plate is cut from 5⅛″×5″×⅜″ plate, having a 1″ hole therethrough for receiving the spindle bolt, said hole located 5/8″ from the main plate attachment. The preferred side plates are cut from 4¾″×5½″×⅛″ plate, with a top length of 2″ and a bottom length of 3″. The preferred bolt guide is cut from 2¼″×3″×⅜″ plate having a 1″ hole centered therethrough for guiding the spindle bolt, said hole spaced 5/8″ from the main plate attachment. The face of the bolt guide measures 1″ in width, tapering to the 2¼″ attachment with the main plate. The preferred spindle bolt 25 is an 18″ length of 15/16″ rod, threaded 1″ at both ends.

In the preferred embodiment, the second portion 30 comprises a front plate 82, a lower stiffener plate 81, a base plate 83, a rear plate 84, a pair of upper stiffener plates 85, 85′ and a top plate 86. The preferred front plate 82 is cut from a 13″×15″×¼″ plate. The upper portion of the cart bracket is 5″ wide×5½″ tall. The hand holds 20 provided therein are ½″×4″, being ½″ inch from the edges. The side portions are 4¼″ tall and 5″ wide. The bottom portion is 3″ wide at its base, widening at a 45 degree angle to 5″ at its junction with the side portion's bottom. The preferred lower stiffener pate 81 is cut from 4½″×4½″×¼″ plate, having a 1½″ hole 2″ inch from the back and bottom sides. The preferred base plate 83 is cut from ⅜″×6″×15″ plate. Four 7/16″ holes are provided within the base plate for attachment to the preferred casters. The preferred rear plate 84 is cut from ¼″×2″×15″ plate and attaches 1/4″ from the edge on the base plate. The preferred upper stiffener plates 85, 85′ are cut from 6″×8″×⅛″, angling from 6″ to 8″ on the back side. The preferred top plate 86 is cut from ¼″×1/2″×4 1/2″ plate.

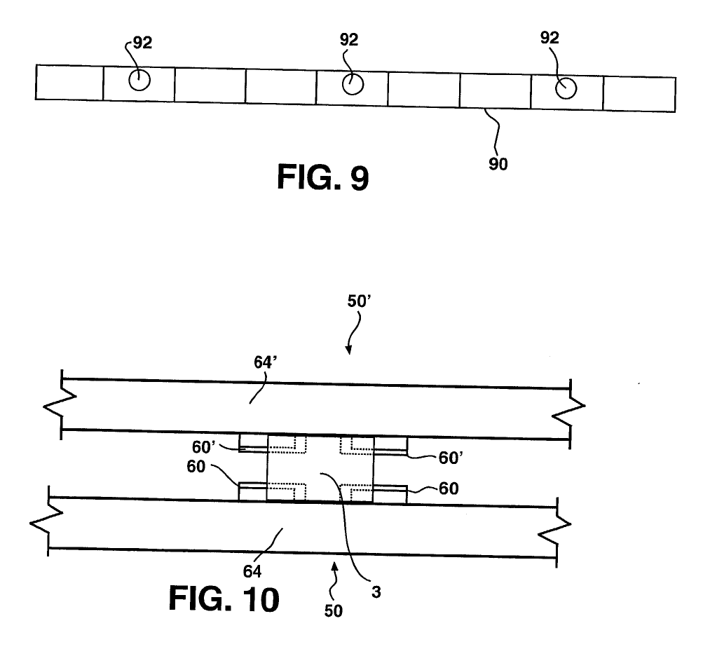

Referring now to FIG. 9, shown is a first embodiment of an alignment channel 90 utilized with the present invention. Such an alignment channel 90 would be utilized to connect several adjacent elevation means together, thereby aligning them and allowing for a more uniform and stable movement of the lifted gondola. This embodiment shows a flat, stiff channel defining a number of holes there-through, each of these holes able to attach to one of the elevation means by encircling the nut washer assembly of the main lift bolt or other attachment means. The preferred alignment channel comprises a roughly 12-foot long length of ⅛″ plate having a number of 2-inch holes drawn 4-feet on center. These 2″ holes for connecting with individual units of the present invention. It is also preferred that a number of ⅛″×1″×5¼″ stiffeners be placed along the alignment channel at 16″ on center for stiffening the plate. It is preferred that 2 alignment channels be used for every 3 units of the present invention, with overlapping alignment channels at the center unit.

Referring now to FIG. 10, shown is a partial view of the preferred method of using the present invention. Shown particularly is how the present invention 10 is used to lift and support the center post 3 of the gondola. It is preferred that the center flanges 60, 60′ each lift a corner of the center post 3, as shown.

In use, a number of units of the present invention would be utilized to move a section of a gondola. While theoretically, if the length of the gondola was short enough, a solitary unit (having two elevation means and two base support connections) could be utilized, it is preferred that multiple units be used. The first step in using the present invention would be the removal of any kick-plates, etc. to obtain access to and locate the horizontal base supports.

Second, first elongated base support connection would be placed on the first side of the horizontal base support and the second elongated base support connection (rotated lengthwise 180 degrees from the orientation of the first elongated base support connection so that the connections face one another) would be placed on the second side of the horizontal base support. Doing so may or may not require the support connections to be laid on their sides and slid sideways under the gondola.

Third, the two support connections are drawn together, being drawn up to each side of the horizontal base support. The operator(s) would then attach the support connections to the elevation means. Then, through use of the jacks or other means of jacking provided on the elevation means, the base support of the gondola would be lifted off the ground and able to be moved. Of course, additional units of the present invention may need to be employed so as to uniformly lift the entire section of gondola. Additionally, multiple units of the alignment channel of FIG. 9 could be utilized to lock adjacent units together, thereby allowing for a solitary unit making for more precise movement and safety during the moving process.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. An apparatus for moving a merchandise gondola, said gondola having at least one horizontal base support for contacting a floor surface, said apparatus comprising:
a first elevation means, said first elevation means having a jack assembly mounted on at least one wheel;
a second elevation means, said second elevation means having a jack assembly mounted on at least one wheel; and
an elongated base support connection for connecting with said base support, said base support connection having a first end opposite a second end, said first end able to releasably connect with said first elevation means, said second end able to releasably connect with said second elevation means;
wherein, said jack assemblies able to raise said attached elongated base support connection first and second ends thereby lifting said horizontal base support and thereby lifting said gondola.

2. The apparatus of claim 1, wherein said elongated base support connection comprises a first support connection and second support connection.

3. The apparatus of claim 2, wherein said first and second support connections each comprise an number of flanges extending perpendicularly from the bottom of said support connections, wherein when facing one another, said first and second support connections with flanges defining a U-shaped channel for receiving said base support therein.

4. An apparatus for moving a merchandise gondola, said gondola having at least one horizontal base support for contacting a floor surface, said apparatus comprising:
a first elevation means, said first elevation means having a jack assembly mounted on at least one wheel;
a second elevation means, said second elevation means having a jack assembly mounted on at least one wheel; and
a first elongated base support connection for connecting with said base support, said first base support connection having a first end opposite a second end, said first end able to releasably connect with said first elevation means, said second end able to releasably connect with said second elevation means;
a second elongated base support connection for connecting with said base support, said second base support connection having a first end opposite a second end, said first end able to releasably connect with said first elevation means, said second end able to releasably connect with said second elevation means;
wherein, said jack assemblies able to raise said attached first and second elongated base support connections first and second ends thereby lifting said horizontal base support and thereby lifting said gondola.

5. An apparatus for moving a merchandise gondola, said gondola having at least one horizontal base support for contacting a floor surface, said horizontal base support having a first vertical side and a second vertical side, said horizontal base support having a bottom side facing said floor surface, said apparatus comprising:
a first elongated base support connection for facing said first vertical side, said first elongated base support connection comprising at least one generally horizontal flange able to contact said bottom side, said first base support connection having a first end opposite a second end, said first end able to releasably connect with said first elevation means, said second end able to releasably connect with said second elevation means;
a second elongated base support connection for facing said second vertical side, said second elongated base support connection comprising at least one generally horizontal flange able to contact said bottom side, said second base support connection having a first end opposite a second end, said first end able to releasably connect with said first elevation means, said second end able to releasably connect with said second elevation means;
a first elevation means for lifting said first and second base support connection first ends, thereby lifting said gondola base support held therein; and
a second elevation means for lifting said first and second base support connection second ends, thereby lifting said gondola base support held therein.
